(19) United States
(12) Patent Application Publication
(10) Pub. No.: US 2010/0033294 A1
(43) Pub. Date: Feb. 11, 2010

(54) FUSE SEAT WITH PROMPTING FUNCTION

(76) Inventors: Wen-Tsung Cheng, Taoyuan (TW); Wen-Ho Cheng, Taoyuan (TW)

Correspondence Address: HDLS Patent & Trademark Services, P.O. BOX 220746, CHANTILLY, VA, 20153-0746, US

(21) Appl. No.: 12/186,654

(22) Filed: Aug. 6, 2008

(51) Int. Cl. H01H 85/32

(52) U.S. Cl. 337/266

(57) ABSTRACT

A fuse seat with prompting function is to provide a fuse plugged therein conductively. The fuse seat includes an insulating body, two electricity-conducting pieces, two electric wires and a light-emitting unit. The insulating body is arranged an accommodating space and is configured a through trough. Two electricity-conducting pieces are respectively arranged in the accommodating space. The fuse is plugged into the accommodating space and is connected conductively to the electricity-conducting pieces. One side of each electric wire is respectively connected to the electricity-conducting pieces electrically and is extended out of the insulating body. The light-emitting unit is embedded fixedly in the insulating body, accommodated in the through trough and connected electrically to the electricity-conducting pieces respectively. When an overload occurs the light-emitting unit generates prompting light for the purpose of identification.

### BACKGROUND OF THE INVENTION

1. Field of the Invention

The present invention generally relates to a fuse seat, in particular, to a fuse seat with prompting function.

2. Description of Prior Art

In general vehicle a fuse seat provided for a fuse to be plugged therein includes an insulating body, a pair of electricity-conducting pieces and an electric wire. The insulating body is arranged an accommodating space, in which the electricity-conducting pieces are fixed. The electric wire is electrically connected to the electricity-conducting pieces respectively, then the fuse is plugged into the accommodating space and is connected conductively to each electricity-conducting piece, thus that a closed circuit is formed, making current able to pass through.

The insulating body is usually connected to a cap fitted over a bottom of the insulating body to prevent the fuse from coming off. Furthermore, since the insulating body is mostly made of opaque material, for example, plastic or rubber, a plurality of fuse seats are arranged in the vehicle to prevent the electric wire from sparking. Therefore, it is impossible to know which fuse is burned down and is needed to be changed when a burning down of fuse occurs, making a user have to check every fuse one by one, thus consuming a lot of time.

Accordingly, a fuse structure of prior arts was developed, on which a light-emitting unit is connected fixedly. When the fuse is burned down the light-emitting unit is electrically conducted to start emitting light. Therefore, it is possible to identify which fuse is burned down and is needed to process a change. But, during use, this structure still has following problems: when installed in the insulating body the fuse is entirely plugged into the insulation body with a cap covered thereon so, when the light-emitting unit emits light it is still impossible to know which fuse is exactly burned down from outside, thus that it is has to open the cap of each fuse seat one by one; in addition, when every time the fuse is changed, since the light-emitting unit is still connected therewith, the light-emitting unit still has to be changed, even it is undamaged, causing waste on use and raising using cost.

Accordingly, aiming to solve aforementioned shortcomings, after a substantially devoted study, in cooperation with the application of relatively academic principles, the inventor has at last proposed the present invention that is designed reasonably to possess the capability to improve the prior arts significantly.

### SUMMARY OF THE INVENTION

The invention is mainly to provide a fuse seat with prompting function by making the fuse short circuit when an overload occurs. In the meantime a light-emitting unit will generate light-emitting prompt for the purpose of identification.

Secondly the invention is to provide a fuse seat with prompting function by embedding a light-emitting unit in the insulating body instead of fixing it to the fuse, thus that cost saving is further achieved.

To summarize, the invention is to provide a fuse seat with prompting function for a fuse plugged therein conductively. The fuse seat includes an insulating body, two electricity-conducting pieces, two electric wires and a light-emitting unit. The insulating body is arranged an accommodating space and is configured a through trough. Two electricity-conducting pieces are respectively arranged in the accommodating space. The fuse is plugged into the accommodating space and is connected conductively to the electricity-conducting pieces. Respectively, one side of each electric wire is connected to the electricity-conducting pieces electrically and is extended out of the insulating body. The light-emitting unit is embedded fixedly in the insulating body, accommodated in the through trough and connected electrically to the electricity-conducting pieces respectively.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective explosive view of the present invention;

FIG. 2 is a using status illustration (A) of the present invention;

FIG. 3 is a using status illustration (B) of the present invention; and

FIG. 4 is an illustration of electrically passing routes of the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

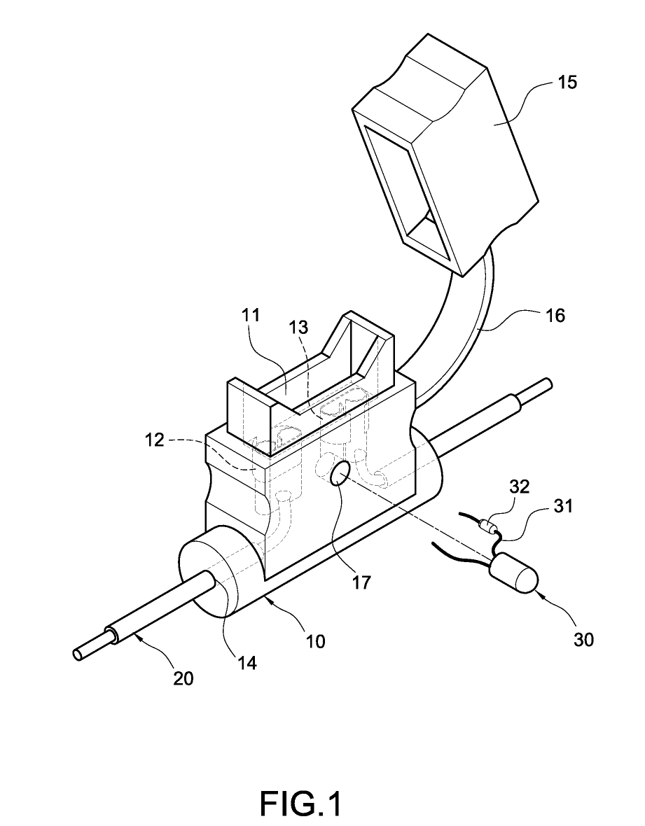

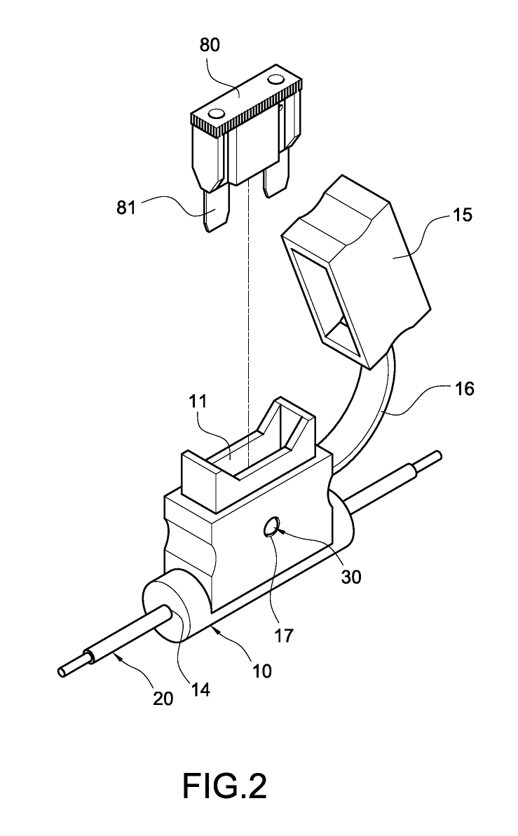

Please refer to FIG. 1, which is a perspective explosive illustration of the present invention. The present invention is to provide a fuse seat with prompting function for a fuse 80 (refer to FIG. 2) plugged therein conductively. The fuse seat includes an insulating body 10, two electric wires 20 and a light-emitting unit 30.

According to a preferable embodiment of the invention, the insulating body 10 is substantially configured as a cuboid and is arranged an accommodating space 11, in which a pair of electricity-conducting pieces are fixed respectively. The electricity-conducting pieces are designated respectively as a first electricity-conducting piece 12 and a second electricity-conducting piece 13. The first electricity-conducting piece 12 and the second electricity-conducting piece 13 are fixed in the insulating body 10 by means of injective enclosure. The insulating body 10 may be made of material of plastic or rubber. The fuse 80 is plugged into the accommodating space 11 and is electrically connected to the first electricity-conducting piece 12 and the second electricity-conducting piece 13 respectively. Two sides of a bottom of the insulating body 10 are arranged a connective through trough 14 respectively corresponding to the first electricity-conducting piece 12 and the second electricity-conducting piece 13. In addition, the insulating body 10 is also extended a connecting tape 16 connected to a cap 15. The cap 15 is able to cover over the insulating body 10 and to seal the accommodating space 11.

The first electricity-conducting piece 12 and the second electricity-conducting piece 13 are bent to a substantial “B” configuration, thus that the fuse 80 can be plugged into the first electricity-conducting piece 12 and the second electricity-conducting piece 13 and can be clipped and hold therein conductively. Respectively, one side of each electric wire 20 is arranged by passing through the connective through trough 14, electrically connected to the first electricity-conducting piece 12 and the second electricity-conducting piece 13 and extended out of the insulating body 10.

The insulating body 10 is also configured a through trough 17 communicated to the accommodating space 11. In this case, the through trough 17 is provided for the light-emitting unit 30 embedded fixedly in the insulating body 10. In the meantime, the light-emitting unit 30 has two connecting legs 31, one of which is connected with a resistance 32, and both of which are respectively connected to the first electricity-conducting piece 12 and the second electricity-conducting piece 3 conductively. In addition, the accommodating space 11, the through trough 17 and the connective through trough 14 are intercommunicated to one another.

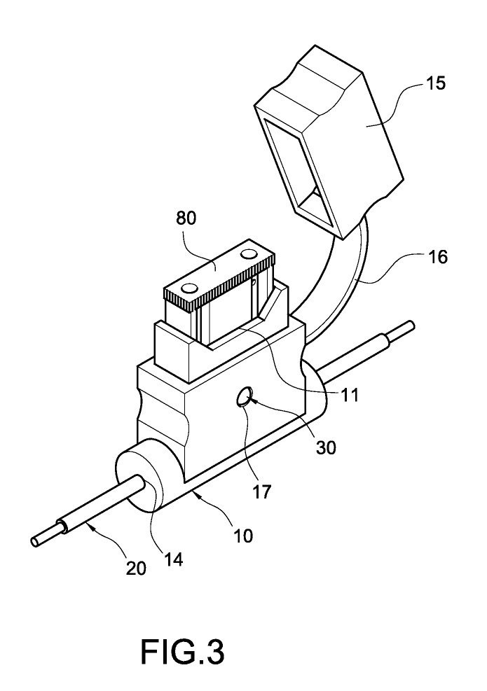

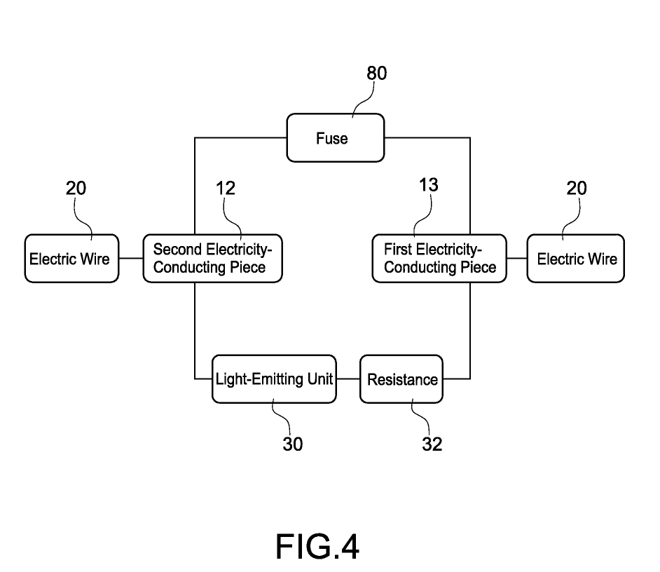

Please refer to FIG. 2 to FIG. 4, which separately are a using status illustration (A) of the present invention, a using status illustration (B) of the present invention and an illustration of electrically passing routes of the present invention. A fuse seat with prompting function according to the present invention is to plug a fuse 80 into an accommodating space 11 during use. The fuse 80 has two conductively connecting pieces 81. When the fuse 80 is plugged into the accommodating space 11, these two conductively connecting pieces 81 are respectively connected to the first electricity-conducting piece 12 and the second electricity-conducting piece 13 conductively. Now, the electric wires 20, the first electricity-conducting piece 12, the second electricity-conducting piece 13 and the fuse 80 are formed into a closed circuit, making current able to pass through. Additionally, the electric wires 20, the first electricity-conducting piece 12, the second electricity-conducting piece 13, the light-emitting unit 30 and the resistance 32 are then formed into another closed circuit.

The light-emitting unit 30 may be a light-emitting diode. Since one connecting leg 31 is still connected with a resistance 32, the resistance value of the light-emitting unit 30 is larger than that of the fuse 80. When the fuse 80, the first electricity-conducting piece 12, and the second electricity-conducting piece 13 are interconnected to one another, current is able to pass through this closed circuit. However, when an overload occurs to make the fuse 80 burned down due to an excess of current or voltage, the current will pass through the light-emitting unit 30 that has a larger resistance instead, making the light-emitting unit 30 emit light.

When the light-emitting unit 30 emits light, it can immediately know from the outside of the insulating body 10 which fuse 80 has been burned down and needed to be changed without opening the cap 15 of the insulating body 10 one by one, thus that a lot of checking time is thereby saved. Furthermore, instead of being fixed to the fuse 80, the light-emitting unit 30 is fixed to the insulating body 10 so, when each time the fuse 80 is changed, the cost of the light-emitting unit 30 can be saved. After a long term of accumulation, a considerable expanse may be saved.

In sum, the fuse seat with prompting function according to the present invention has following merits:

1. When an over load occurs in the fuse 80, the light-emitting unit 30 emits light at once to give a prompting warning through a generation of short circuit. Accordingly, a user can immediately process a change of fuse 80, increasing a lot of conveniences in terms of use.

2. Since of a connection to the insulating body 10, the light-emitting unit 30 mustn't be changed every time the fuse 80 is changed, so it can save cost and reduce waste.

According to the aforementioned structure, a fuse seat with prompting function of the present invention is thereby obtained.

Summarizing aforementioned description, the invention is an indispensably novel structure for a fuse seat indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

However, the aforementioned description is only a preferable embodiment according to the present invention, being not used to limit the patent scope of the invention, so equivalently structural variation made to the contents of the present invention, for example, description and drawings, is all covered by the claims claimed thereinafter.

What is claimed is:

1. A fuse seat with prompting function, provided for a fuse plugged therein conductively, including:
an insulating body, which is arranged an accommodating space and is configured a through trough;
two electricity-conducting pieces, which are fixed in the accommodating space, and to which the fuse plugged in the accommodating space is connected conductively;
two electric wires, one side of each electric wire being electrically connected to one of the electricity-conducting pieces and extended out of the insulating body; and
a light-emitting unit, which is embedded fixedly to the insulating body and is accommodated in the through trough, and which is electrically connected to the electricity-conducting pieces;
wherein the fuse is shorted when an over load occurs, making the light-emitting unit generate a light-emitting prompt.

2. The fuse seat with prompting function according to claim 1, further including a resistance electrically connected to the light-emitting unit and the electricity-conducting piece.

3. The fuse seat with prompting function according to claim 2, wherein the electricity-conducting pieces and the light-emitting unit are fixed onto the insulating body by an injective enclosure.

4. The fuse seat with prompting function according to claim 3, wherein each of two sides of a bottom of the insulating body is arranged a connective through trough corresponding to each of the electricity-conducting pieces for the electric wires to pass through.

5. The fuse seat with prompting function according to claim 4, wherein the light-emitting unit has two connecting legs connected to the electricity-conducting pieces respectively, and wherein one of the connecting legs is electrically connected to the resistance.

6. The fuse seat with prompting function according to claim 5, wherein the insulating body is also connected to a cap that seals the accommodating space.

7. The fuse seat with prompting function according to claim 6, wherein the cap and the insulating body are connected to each other by a connecting tape.

8. The fuse seat with prompting function according to claim 4, wherein the accommodating space, the through trough and the connective through trough are intercommunicated to one another.

9. The fuse seat with prompting function according to claim 1, wherein the light-emitting unit is a light-emitting diode.

10. The fuse seat with prompting function according to claim 1, wherein the insulating unit is made of plastic or rubber.

11. The fuse seat with prompting function according to claim 1, wherein the electricity-conducting pieces are substantially shown as a “B” configuration.
